(19) United States
(12) Patent Application Publication
(10) Pub. No.: US 2026/0050256 A1
(43) Pub. Date: Feb. 19, 2026

(54) BUILDING MANAGEMENT SYSTEM CONTROLLER WITH A BMS CONTROL CONTAINER AND ONE OR MORE SUPPORT CONTAINERS OPERATIVELY COMMUNICATING VIA A PUBLISH-SUBSCRIBE MESSAGE BROKER

(71) Applicant: Honeywell International Inc., Charlotte, NC (US)

(72) Inventors: Chris Inkpen, Horsham (GB); Tony Lu, Atlanta, GA (US); Sumuditha Ranawaka, Eastbourne (GB); Rory Stewart Foxley, Horsham (GB); Simon Wilton, Sussex (GB)

(21) Appl. No.: 18/806,437

(22) Filed: Aug. 15, 2024

(51) Int. Cl. G05B 23/02

(52) U.S. Cl. CPC G05B 23/0275; G05B 23/024; G05B 23/027

(57) ABSTRACT

A BMS controller includes a BMS control container operating in a first sandbox that is associated with first processing resources of the BMS controller. The BMS control container implements BMS control logic that receives sensed values from external BMS sensors and provides one or more control signals to external BMS control devices that are based at least in part on the sensed values. The BMS controller includes a publish-subscribe message broker container operating in a second sandbox that is associated with second processing resources of the BMS controller. The BMS controller includes support containers that each operate in a corresponding sandbox associated with corresponding processing resources of the BMS controller. Each of the support containers communicate with the BMS control container and/or other support containers via the publish-subscribe message broker container.

### TECHNICAL FIELD

The present disclosure relates generally to building management systems, and more particularly to building management system controllers that include containerized applications.

### BACKGROUND

Building management system controllers are used in a wide variety of building management systems in order to control operation of various components within the building management system. Many building management system controllers have limited resources and limited capabilities. Adding additional capabilities can be expensive and complicated. What would be desired are systems and methods for increasing the capabilities of building management system controllers in an efficient and secure manner.

### SUMMARY

The present disclosure relates generally to building management systems, and more particularly to systems and methods for increasing the capabilities of building management system controllers in an efficient and secure manner. This may be accomplished by, for example, deploying a BMS control container and one or more separate support containers in a building management system controller. Each container may be a lightweight, standalone, executable software package that include everything needed to run, including code, runtime, system tools, system libraries and settings. Each container may be run in a sandbox for improved security and resource utilization. Each sandbox may include a lightweight virtual machine shielded from direct interaction with physical hardware of the building management system controller, and may restrict access to specific resources to help ensure confinement to the sandbox. In some cases, the BMS control container and the one or more separate support containers of the building management system controller may communicate via a publish-subscribe message broker container, which runs in its own separate sandbox.

An example may be found in a Building Management System (BMS) controller that includes a plurality of processing resources, a housing that houses the plurality of processing resources, and a plurality of I/O ports that are accessible from outside of the housing for interfacing with one or more external devices including one or more external BMS sensors and one or more external BMS control devices. The illustrative BMS controller includes a BMS control container that operates in a first sandbox associated with first processing resources of the BMS controller. The BMS control container implements BMS control logic that receives one or more sensed values from the one or more external BMS sensors via one or more of the plurality of I/O ports, and provides one or more control signals to one or more of the external BMS control devices via one or more of the plurality of I/O ports, wherein each of the one or more control signals are based at least in part on one or more of the sensed values. The illustrative BMS controller further includes a publish-subscribe message broker container that operates in a second sandbox that is associated with second processing resources of the BMS controller. The illustrative BMS controller further includes one or more support containers that each operate in a corresponding sandbox associated with corresponding processing resources of the BMS controller. Each of the one or more support containers communicating with the BMS control container and/or one or more other support containers via the publish-subscribe message broker container.

Another example may be found in operating a Building Management System (BMS) controller. The illustrative method includes operating a BMS control container in a first sandbox associated with first processing resources of the BMS controller, the BMS control container executing BMS control logic that receives one or more sensed values from one or more external BMS sensors and provides one or more control signals to one or more external BMS control devices. A publish-subscribe message broker container is operated. The method includes operating one or more support containers each operating in a corresponding sandbox associated with corresponding processing resources of the BMS controller, each of the one or more support containers communicating with the BMS control container and/or one or more other support containers via the publish-subscribe message broker container.

Another example may be found in a non-transitory computer readable medium storing instructions thereon that when executed by one or more processors of a Building Management System (BMS) controller cause the BMS controller to operate a BMS control container in a first sandbox associated with first processing resources of the BMS controller, the BMS control container executing BMS control logic that receives one or more sensed values from one or more external BMS sensors and provides one or more control signals to one or more external BMS control devices. The one or more processors are further caused to operate a publish-subscribe message broker. The one or more processors are further caused to operate one or more support containers each operating in a corresponding sandbox associated with corresponding processing resources of the BMS controller, each of the one or more support containers communicating with the BMS control container and/or one or more other support containers via the publish-subscribe message broker. In some cases, one or more of the support containers each implement a corresponding Artificial Intelligence/Machine Learning (AI/ML) algorithm. The first processing resources associated with the first sandbox hosting the BMS control container includes a CPU of the BMS controller but does not include a GPU and/or a NPU of the BMS controller, and the processing resources associated with each of the one or more of the support containers that implement a corresponding Artificial Intelligence/Machine Learning (AI/ML) algorithm includes the GPU and/or the NPU of the BMS controller.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative Building Management System (BMS) controller;

FIG. 2 is a schematic block diagram showing an illustrative controller; and

FIG. 3 is a flow diagram showing an illustrative method for operating a BMS controller such as the BMS controller of FIG. 1.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure.

Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or”unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

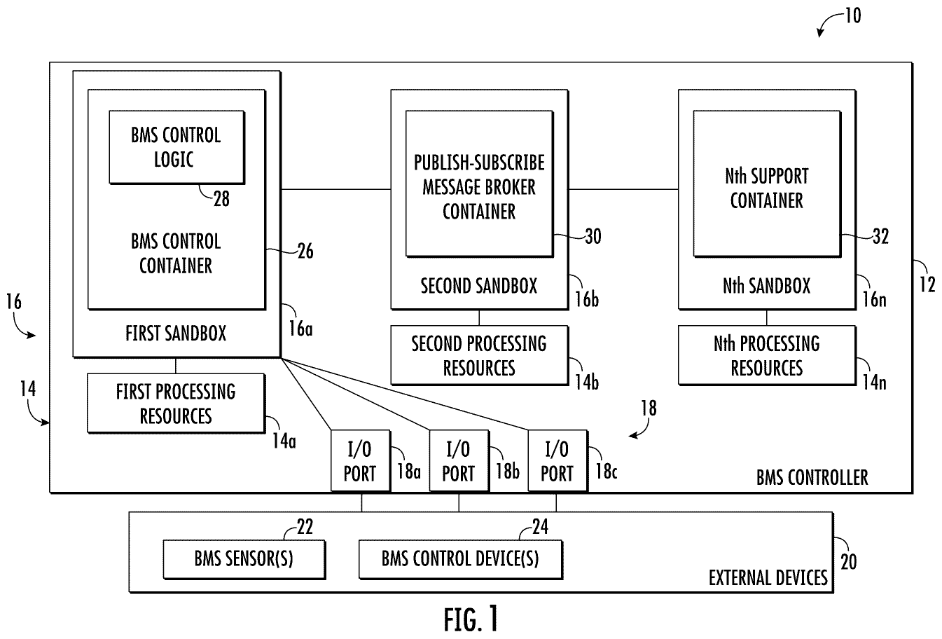

FIG. 1 is a schematic block diagram showing an illustrative Building Management System (BMS) controller 10. The illustrative BMS controller 10 includes a housing 12 that houses a plurality of processing resources 14, individually labeled as first processing resources 14a, second processing resources 14b and through Nth processing resources 14n. The processing resources 14 may include a Central Processing Unit (CPU). The processing resources 14 may include one or more of a Graphics Processing Unit (GPU) and a Neural Processing Unit (NPU), for example. Other processing resources 14 may also be included, such as memory resources. In some cases, some of the processing resources 14 may be shared and/or divided between various aspects of the BMS controller 10, hence the division into as many as “N” processing resources.

In some cases, the BMS controller 10 may include a number of sandboxes 16, individually labeled as a first sandbox 16a, a second sandbox 16b and through an Nth sandbox 16n. Each sandbox may include a lightweight virtual machine shielded from direct interaction with physical hardware of the BMS controller 10, and may restrict access to specific resources to help ensure confinement to the sandbox. Each sandbox 16 may have access to collection of resources within the BMS controller 10 that may be used to run particular applications and/or processes in a way that allows the particular applications and/or processes to have access to some resources within the particular sandbox 16 in which they are running but not to have access to resources within other of the sandboxes 16. In some cases, the use of the sandboxes 16 permits the BMS controller 10 to access implement additional functionality without creating security risks that could otherwise occur via the BMS controller 10 receiving outside data and/or software applications. There may be any number of sandboxes 16, and correspondingly any number of sets of processing resources 14.

The illustrative BMS controller 10 includes a number of I/O ports 18, individually labeled as 18a, 18b and 18c. While a total of three I/O ports 18 are shown, it will be appreciated that the BMS controller 10 may include any number of I/O ports 18. The BMS controller 10 may include considerably more than three I/O ports 18, particularly if the BMS controller 10 is coupled with an I/O module that adds additional I/O ports 18. Each of the I/O ports 18 may be accessible from outside the housing 12 such that cables (not shown) connected to the I/O ports 18 may be operably coupled to, or interface with, one or more external devices 20 (e.g. sensors, actuators, servers, etc.). In some cases, the external devices 20 may include one or more BMS sensors 22 and/or one or more BMS control devices 24. In some cases, one or more of the I/O ports 18 may include an IT (informational technology) port or an IoT (Internet of Things) port.

The illustrative BMS controller 10 includes a BMS control container 26 that operates within the first sandbox 16a. The first sandbox 16a is associated with the first processing resources 14a, and thus the BMS control container 26 is able to utilize the first processing resources 14a. In some cases, the BMS control container 26 is a docker container. In some cases, the BMS control container 26 is a SNAP (Single Application Containerized Platform) container. In some cases, the BMS control container 26 may be a docker container that is running inside of a SNAP container. The BMS control container 26 includes and implements BMS control logic 28 that receives one or more sensed values from one or more external BMS sensors 22 via one or more of the I/O ports 18. The BMS control logic 28 providing one or more control signals to one or more external BMS control devices 24 via one or more of the I/O ports 18. In some cases, at least some of the one or more control signals are based at least in part upon one or more of the sensed values.

The illustrative BMS controller 10 includes a publish-subscribe message broker container 30 that operates within the second sandbox 16b. The second sandbox 16b is associated with the second processing resources 14b, and thus the publish-subscribe message broker container 30 is able to utilize the second processing resources 14b. In some cases, the publish-subscribe message broker container 30 is a docker container. In some cases, the publish-subscribe message broker container 30 is a SNAP (Single Application Containerized Platform) container. In some cases, the publish-subscribe message broker container 30 may be a docker container that is running inside of a SNAP container. In some cases, the publish-subscribe message broker container 30 may include an MQTT (Message Queuing Telemetry Transport) broker, which is a lightweight messaging protocol.

The illustrative BMS controller 10 includes one or more support containers, each of which operate in a corresponding sandbox 16 and are associated with corresponding processing resources of the BMS controller 10. There may be any number of support containers, each operating within a corresponding sandbox 16. As shown, an Nth support container 32 operates within an Nth sandbox 16n. The Nth sandbox 16n is associated with the Nth processing resources 14n, and thus the Nth support container 32 is able to utilize the Nth processing resources 14n. In some cases, the Nth support container 32 is a docker container. In some cases, the Nth support container 32 is a SNAP (Single Application Containerized Platform) container. In some cases, the Nth support container 32 may be a docker container that is running inside of a SNAP container. In some cases, each of the support containers, such as the Nth support container 32, may communicate with the BMS control container 26 and/or with other support containers via the publish-subscribe message broker container 30.

In some cases, one or more of the support containers such as the Nth support container 32 may implement a corresponding Artificial Intelligence/Machine Learning (AI/ML) algorithm. As an example, the AI/ML algorithm may include a loop turning algorithm for tuning an integral control loop of the BMS control container 26. As another example, the AI/ML algorithm may include a classification algorithm for classifying a state of a BMS system that is at least partially controlled by the BMS controller 10 based at least in part on one or more sensed values from the one or more external BMS sensors 22. In some cases, the AI/ML algorithm may include an anomaly detection algorithm for detecting an anomaly in the BMS system that is at least partially controlled by the BMS controller 10 based at least in part on one or more sensed values from the one or more external BMS sensors 22.

In some cases, the processing resources 14 include a Central Processing Unit (CPU) and one or more of a Graphics Processing Unit (GPU) and/or a Neural Processing Unit (NPU). The first processing resources 14a that are associated with the first sandbox 16a hosting the BMS control container 26 may include the CPU but may not the GPU and/or the NPU. The processing resources associated with each of the one or more support containers (such as the Nth support container 32) that implement a corresponding AI/ML algorithm includes the GPU and/or the NPU.

In some cases, the I/O ports 18 may include one or more IT and/or IoT ports, and one or more of the support containers (such as the Nth support container 32) may provide an interface between the IT and/or IoT ports and the publish-subscribe message broker container 30. In some cases, the one or more of the support containers (such as the Nth support container 32) that provides an interface between the IT and/or IoT ports and the publish-subscribe message broker container 30 may include an event driven client, a REpresentational State Transfer (REST) client and/or a publish-subscribe message broker client. These are just examples.

In some cases, the BMS control container 26 may itself include a publish-subscribe message broker for receiving one or more sensed values from the one or more external BMS sensors 22 via one or more of the plurality of I/O ports 18 and/or providing one or more control signals to one or more of the external BMS control devices 24 via one or more of the plurality of I/O ports 18. In some cases, the BMS controller 10 receives and/or generates BMS data, and wherein one or more of the support containers (such as the Nth support container 32) implement a relational database management function for storing, managing and/or querying the BMS data. In some cases, the BMS controller 10 receives and/or generates alarms and/or faults, and wherein one or more of the support containers (such as the Nth support container 32) implement a root cause analysis function for identifying a root cause of one or more of the alarms and/or faults. In some cases, one or more of the external BMS sensors 22 may include one or more occupancy sensors, and wherein one or more of the support containers implement an occupancy prediction function for predicting occupancy levels, and supplying the predicted occupancy levels to the BMS Control container 26.

In some cases, one of the support containers (such as the Nth support container 32) may implement a weather API module that is configured to fetch data from third-party cloud services, and provide control point forecasting to the BMS Control container 26. In some cases, one of the support containers (such as the Nth support container 32) may implement an occupancy aggregation module that aggregates multiple occupancy characteristics to make them available as a control point to the BMS Control container 26. In some cases, one of the support containers (such as the Nth support container 32) may implement a lighting system integration module that allows for control and monitoring of lighting systems by the BMS Control container 26. In some cases, one of the support containers (such as the Nth support container 32) may implement a connected power socket module that allows for managing and monitoring connected power sockets by the BMS Control container 26. These are just examples.

It is contemplated that the plurality of processing resources of the BMS Controller 10 may be manually assigned to the first processing resources 14a, second processing resources 14b and Nth processing resources 14n. In some cases, the utilization of the plurality of processing resources of the BMS Controller 10 may be monitored over time and dynamically assigned to the first processing resources 14a, second processing resources 14b and Nth processing resources 14n based on the current and/or predicted load of each of the first processing resources 14a, second processing resources 14b and Nth processing resources 14n. This may help properly allocate the limited resources of the BMS Controller 10 to each of the BMS Control Container 26, the publish-subscribe message broker container 30 and the one or more support containers, depending on current and/or predicted needs.

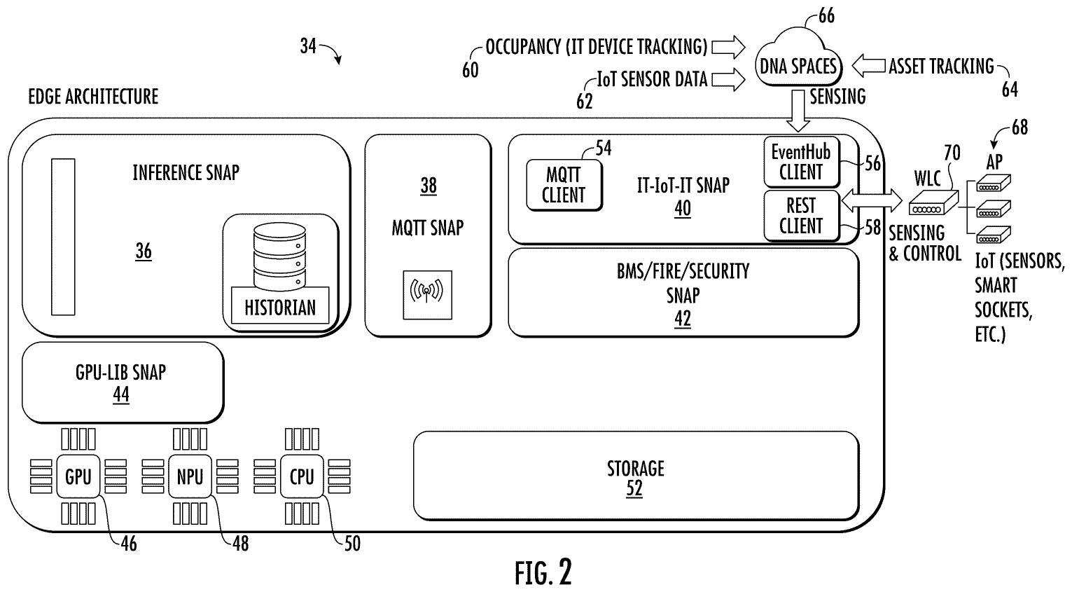

FIG. 2 is a schematic block diagram showing an illustrative controller 34. The controller 34 may be used as a BMS controller. The BMS controller may be an HVAC system controller, a Fire system controller, a Security system controller and/or any other suitable BMS controller. The controller 34 includes a number of SNAP (Single Application Containerized Platform) containers, such as an Inference AI SNAP container 36, an MQTT SNAP container 38, an IT-IoT-OT SNAP container 40, a BMS/FIRE/SECURITY SNAP container 42 and a GPU-LIB SNAP container 44. The illustrative controller 34 includes processing resources such as a GPU 46, an NPU 48, a CPU 50 and storage 52. The illustrative IT-IoT-OT SNAP container 40 includes an MQTT Client 54, an EventHub Client 56 and a REST client 58. The EventHub Client 56 may be configured to receive data from various sources and/or devices, such as IT (Information Technology) data 60 (such as occupancy data), IoT sensor data 62 and/or asset tracking data 64 through a DNA Spaces 66. The REST client 58 may be configured to receive AP (Access Point) information 68 via a WLC (Wireless LAN Controller) block 70. This and other data may be injected and used by one or more of the Inference AI SNAP container 36 and/or the BMS/FIRE/SECURITY SNAP container 42 to help improve the control of a BMS system by controller 34.

In some cases, the BMS/FIRE/SECURITY SNAP container 42 may include a SNAP container running on a virtualized ARM Machine (Advanced RISC Machine) that interacts with the CPU 50 of the controller 34. Due to their low costs, low power consumption, and low heat generation, ARM machines are useful for embedded systems. In some cases, the BMS/FIRE/SECURITY container 42 may include a docker container, rather than a SNAP container. In some cases, the BMS/FIRE/SECURITY SNAP container 42 may include a SNAP container that itself executes a docker environment inside the SNAP. The docket environment then executes one or more docket containers. Because of the versatility of the docket environment, such as the ability to run on various processors and Operating systems, and the ability to run programs in python, C++, Java and/or other programming languages, docker containers may be useful during development of the software for the controller 34. Once development is complete, the software may be converted to run in a SNAP container (e.g. running the Linux OS) rather than the docket environment. The BMS/FIRE/SECURITY SNAP container 42 may then executed the SNAP container during operation.

In some cases, the AI SNAP container 36 may execute the Ubunto operating system (OS). The Ubunto OS include a GPU library (GPU-LIB). In some cases, the GPU library (GPU-LIB) which may be executed in a separate GPU-LIB SNAP 44. The GPU-LIB provides interface functions for interfacing with the GPU 46 and/or NPU 48. These are particularly useful in running Artificial Intelligence (AI) SNAP 36. In some cases, the AI SNAP container 36 may execute TensorFlowLite. TensorFlowLite is a lightweight AI engine that allows for lightweight execution of AI models for forecasting, classification and other AI functions.

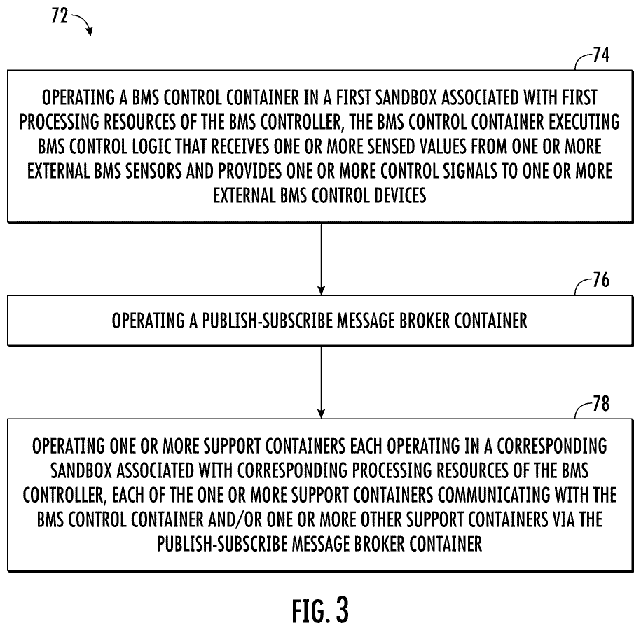

FIG. 3 is a flow diagram showing an illustrative method 72 for operating a Building Management System (BMS) controller (such as the BMS controller 10). The illustrative method 72 includes operating a BMS control container (such as the BMS control container 26) in a first sandbox (such as the first sandbox 16a) associated with first processing resources of the BMS controller (such as the first processing resources 14a), the BMS control container executing BMS control logic (such as the BMS control logic 28) that receives one or more sensed values from one or more external BMS sensors (such as the BMS sensors 22) and provides one or more control signals to one or more external BMS control devices (such as the BMS control devices 24), as indicated at block 74. A publish-subscribe message broker container is operated, as indicated at block 76. One or more support containers each operating in a corresponding sandbox associated with corresponding processing resources of the BMS controller are operated, each of the one or more support containers communicating with the BMS control container and/or one or more other support containers via the publish-subscribe message broker container, as indicated at block 78.

In some cases, the BMS control container, the publish-subscribe message broker container and the one or more support containers may each include a Single Application Containerized Platform (SNAP) container. One or more of the support containers may each implement a corresponding Artificial Intelligence/Machine Learning (AI/ML) algorithm, and wherein the first processing resources associated with the first sandbox hosting the BMS control container includes a CPU of the BMS controller but not a GPU and/or a NPU of the BMS controller, and the processing resources associated with each of the one or more support containers that implement a corresponding Artificial Intelligence/Machine Learning (AI/ML) algorithm includes the GPU and/or the NPU of the BMS controller. In some cases, one or more of the support containers may provide an interface between one or more IT and/or IoT ports and the publish-subscribe message broker container.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed:

1. A Building Management System (BMS) controller comprising:
a plurality of processing resources;
a housing that houses the plurality of processing resources;
a plurality of I/O ports accessible from outside of the housing for interfacing with one or more external devices including one or more external BMS sensors and one or more external BMS control devices;
a BMS control container operating in a first sandbox associated with first processing resources of the BMS controller, the BMS control container implementing BMS control logic that receives one or more sensed values from the one or more external BMS sensors via one or more of the plurality of I/O ports, and provides one or more control signals to one or more of the external BMS control devices via one or more of the plurality of I/O ports, wherein each of the one or more control signals are based at least in part on one or more of the sensed values;
a publish-subscribe message broker container operating in a second sandbox associated with second processing resources of the BMS controller; and
one or more support containers each operating in a corresponding sandbox associated with corresponding processing resources of the BMS controller, each of the one or more support containers communicating with the BMS control container and/or one or more other support containers via the publish-subscribe message broker container.

2. The BMS controller of claim 1, wherein the publish-subscribe message broker container comprises an MQTT broker.

3. The BMS controller of claim 1, wherein the BMS control container, the publish-subscribe message broker container and the one or more support containers each comprise a docker container.

4. The BMS controller of claim 1, wherein the BMS control container, the publish-subscribe message broker container and the one or more support containers each comprise a Single Application Containerized Platform (SNAP) container.

5. The BMS controller of claim 1, wherein one or more of the BMS control container, the publish-subscribe message broker container and the one or more support containers each comprise docker container running in a Single Application Containerized Platform (SNAP) container.

6. The BMS controller of claim 1, wherein one or more of the support containers each implement a corresponding Artificial Intelligence/Machine Learning (AI/ML) algorithm.

7. The BMS controller of claim 6, wherein the plurality of processing resources of the BMS controller includes a Central Processing Unit (CPU) and one or more of a Graphics Processing Unit (GPU) and/or a Neural Processing Unit (NPU), and wherein:
the first processing resources associated with the first sandbox hosting the BMS control container includes the CPU but does not include the GPU and/or the NPU; and
the processing resources associated with each of the one or more support containers that implement a corresponding Artificial Intelligence/Machine Learning (AI/ML) algorithm includes the GPU and/or the NPU.

8. The BMS controller of claim 6, wherein the corresponding Artificial Intelligence/Machine Learning (AI/ML) algorithm comprises one or more of:
a loop turning algorithm for tuning an integral control loop of the BMS control container;
a classification algorithm for classifying a state of a BMS system that is at least partially controlled by the BMS controller based at least in part on one or more sensed values from the one or more external BMS sensors; and
an anomaly detection algorithm for detecting an anomaly in the BMS system that is at least partially controlled by the BMS controller based at least in part on one or more sensed values from the one or more external BMS sensors.

9. The BMS controller of claim 1, wherein the plurality of I/O ports include one or more IT and/or IoT ports, and one or more of the support containers provides an interface between the IT and/or IoT ports and the publish-subscribe message broker container.

10. The BMS controller of claim 1, wherein the one or more of the support containers that provides an interface between the IT and/or IoT ports and the publish-subscribe message broker container include an event driven client, a REpresentational State Transfer (REST) client and/or a publish-subscribe message broker client.

11. The BMS controller of claim 1, wherein the BMS control container includes a publish-subscribe message broker for receiving one or more sensed values from the one or more external BMS sensors via one or more of the plurality of I/O ports and/or providing one or more control signals to one or more of the external BMS control devices via one or more of the plurality of I/O ports.

12. The BMS controller of claim 1, wherein the BMS controller receives and/or generates BMS data, and wherein one or more of the support containers implement a relational database management function for storing, managing and/or querying the BMS data.

13. The BMS controller of claim 1, wherein the BMS controller receives and/or generates alarms and/or faults, and wherein one or more of the support containers implement a root cause analysis function for identifying a root cause of one or more of the alarms and/or faults.

14. The BMS controller of claim 1, wherein one or more of the external BMS sensors includes one or more occupancy sensors, and wherein one or more of the support containers implement an occupancy prediction function for predicting occupancy levels.

15. A method for operating a Building Management System (BMS) controller, the method comprising:
operating a BMS control container in a first sandbox associated with first processing resources of the BMS controller, the BMS control container executing BMS control logic that receives one or more sensed values from one or more external BMS sensors and provides one or more control signals to one or more external BMS control devices;
operating a publish-subscribe message broker container; and
operating one or more support containers each operating in a corresponding sandbox associated with corresponding processing resources of the BMS controller, each of the one or more support containers communicating with the BMS control container and/or one or more other support containers via the publish-subscribe message broker container.

16. The method of claim 15, wherein the BMS control container, the publish-subscribe message broker container and the one or more support containers each comprise a Single Application Containerized Platform (SNAP) container.

17. The method of claim 15, wherein one or more of the support containers each implement a corresponding Artificial Intelligence/Machine Learning (AI/ML) algorithm, and wherein the first processing resources associated with the first sandbox hosting the BMS control container includes a CPU of the BMS controller but does not include a GPU and/or a NPU of the BMS controller, and the processing resources associated with each of the one or more support containers that implement a corresponding Artificial Intelligence/Machine Learning (AI/ML) algorithm includes the GPU and/or the NPU of the BMS controller.

18. The method of claim 15, wherein one or more of the support containers provides an interface between one or more IT and/or IoT ports and the publish-subscribe message broker container.

19. A non-transitory computer readable medium storing instructions thereon that when executed by one or more processors of a Building Management System (BMS) controller cause the BMS controller to:
operate a BMS control container in a first sandbox associated with first processing resources of the BMS controller, the BMS control container executing BMS control logic that receives one or more sensed values from one or more external BMS sensors and provides one or more control signals to one or more external BMS control devices;
operate a publish-subscribe message broker;
operate one or more support containers each operating in a corresponding sandbox associated with corresponding processing resources of the BMS controller, each of the one or more support containers communicating with the BMS control container and/or one or more other support containers via the publish-subscribe message broker; and
wherein one or more of the support containers each implement a corresponding Artificial Intelligence/Machine Learning (AI/ML) algorithm, and wherein the first processing resources associated with the first sandbox hosting the BMS control container includes a CPU of the BMS controller but does not include a GPU and/or a NPU of the BMS controller, and the processing resources associated with each of the one or more of the support containers that implement a corresponding Artificial Intelligence/Machine Learning (AI/ML) algorithm includes the GPU and/or the NPU of the BMS controller.

20. The non-transitory computer readable medium of claim 19, wherein one or more of the support containers provides an interface between one or more IT and/or IoT ports and the publish-subscribe message broker.
